(19) United States
(12) Patent Application Publication
(10) Pub. No.: US 2011/0015890 A1
(43) Pub. Date: Jan. 20, 2011

(54) TEST APPARATUS

(75) Inventors: Hironaga YAMASHITA, Saitama (JP); Noriyuki MASUDA, Saitama (JP); Kunihiko KAWASAKI, Saitama (JP)

Correspondence Address: Masao Yoshimura, 333 W. El Camino Real, Suite 380, Sunnyvale, CA, 94087, US

(73) Assignee: ADVANTEST CORPORATION, Tokyo (JP)

(21) Appl. No.: 12/824,108

(22) Filed: Jun. 25, 2010

Related U.S. Application Data
(63) Continuation of application No. PCT/JP2009/002995, filed on Jun. 29, 2009.

(51) Int. Cl. G06F 19/00

(52) U.S. Cl. 702/120

(57) ABSTRACT

Provided is a test apparatus that tests a device under test, comprising a test module that transmits and receives signals to and from the device under test; and a test control section that executes a test program for testing the device under test and that instructs the test module to execute a function designated by the test program from among a plurality of functions of the test module. The test module includes a signal input/output section that transmits and receives signals to and from the device under test; and a module control section that executes a function program according to the function designated by the test program and that accesses at least one of a register and a memory in the signal input/output section.

### BACKGROUND

1. Technical Field

The present invention relates to a test apparatus.

2. Related Art

A conventional test apparatus is known that tests a device under test such as an analog circuit, a digital circuit, a memory, or a system on chip (SOC), as shown in International Publication WO 2007/018020, for example.

In such a test apparatus, however, a computer, which may be a work station, serves as both a user interface and to control setting of the test apparatus and a series of test operations performed by the test apparatus. The control apparatus, which may be a computer, can desirably set suitable values in the many registers of the test apparatus and provide instructions at various timings during testing. Accordingly, the test apparatus should be able to perform this setting and instructing accurately for the test apparatus.

### SUMMARY

Therefore, it is an object of an aspect of the innovations herein to provide a test apparatus, which are capable of overcoming the above drawbacks accompanying the related art. The above and other objects can be achieved by combinations described in the independent claims. The dependent claims define further advantageous and exemplary combinations of the innovations herein.

According to a first aspect related to the innovations herein, one exemplary test apparatus may include a test apparatus that tests a device under test, comprising a test module that transmits and receives signals to and from the device under test; and a test control section that executes a test program for testing the device under test and that instructs the test module to execute a function designated by the test program from among a plurality of functions of the test module. The test module includes a signal input/output section that transmits and receives signals to and from the device under test; and a module control section that executes a function program according to the function designated by the test program and that accesses at least one of a register and a memory in the signal input/output section.

The summary clause does not necessarily describe all necessary features of the embodiments of the present invention. The present invention may also be a sub-combination of the features described above. The above and other features and advantages of the present invention will become more apparent from the following description of the embodiments taken in conjunction with the accompanying drawings.

### BRIEF DESCRIPTION OF THE DRAWINGS

FIG. 1 shows a configuration of a test apparatus 100 according to an embodiment of the present invention, along with a device under test 10.

FIG. 2 shows the basics of the control process performed by the test apparatus 100 of the present embodiment on a horizontal time axis.

FIG. 3 shows the basics of function processes performed by the test apparatus 100 of the present embodiment on a horizontal time axis.

FIG. 4 shows a process flow of the test apparatus 100 according to the present embodiment.

### DESCRIPTION OF EXEMPLARY EMBODIMENTS

Hereinafter, some embodiments of the present invention will be described. The embodiments do not limit the invention according to the claims, and all the combinations of the features described in the embodiments are not necessarily essential to means provided by aspects of the invention.

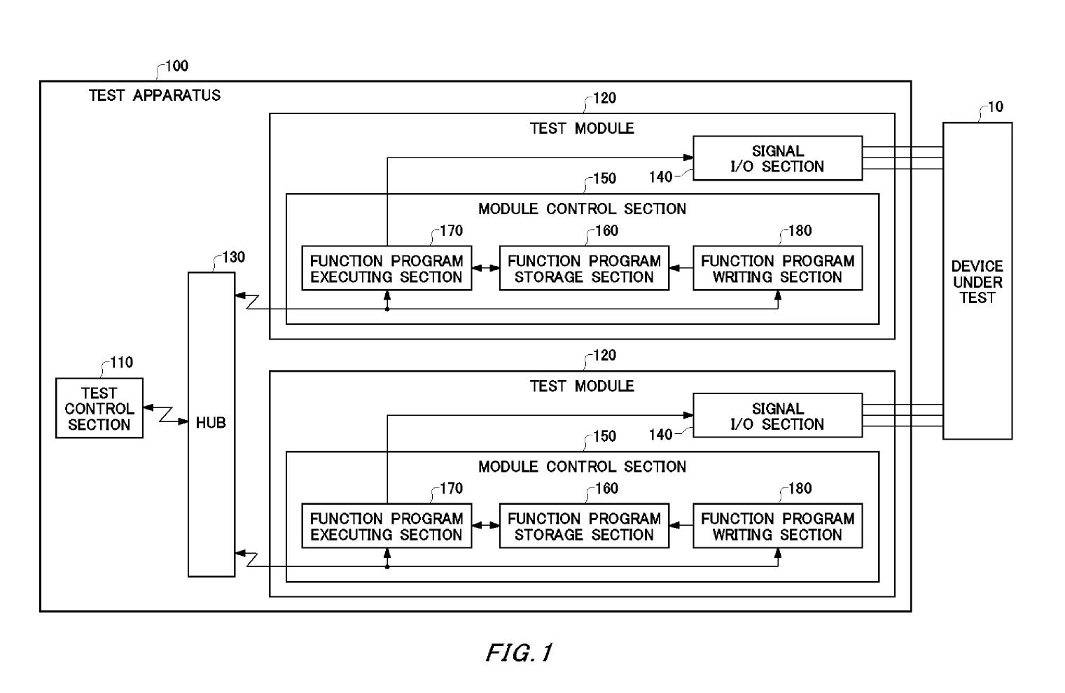

FIG. 1 shows a configuration of a test apparatus 100 according to an embodiment of the present invention, along with a device under test 10. The test apparatus 100 tests the device under test 10, which may be an analog circuit, a digital circuit, a memory, a system on chip (SOC), or the like. The test apparatus 100 inputs to the device under test 10 a test signal based on a test pattern for testing the device under test 10, and judges acceptability of the device under test 10 based on an output signal output by the device under test 10 in response to the test signal.

The test apparatus 100 improves the throughput of device testing by using transmission with an effective bus and an efficient transmission timing for a control signal and data signal transmitted between a control apparatus and the test apparatus body. The test apparatus 100 includes a test control section 110, test modules 120, and a hub 130.

The test control section 110 executes a test program for testing the device under test 10, and instructs the test modules 120 to perform functions designated by the test program from among a plurality of functions that the test modules 120 have. The test control section 110 is connected to the hub 130 via one or more universal or dedicated high-speed serial buses or the like. Ethernet (Registered Trademark), USB, or Serial Rapid IO, for example, can be used as a universal serial bus.

The test control section 110 preferably instructs the test modules 120 to perform the functions designated by the test program using burst transmission that includes a plurality of words. The test control section 110 may use, as the burst transmission, packet transmission or DMA (Direct Memory Access) transmission for the purpose of transmitting a large amount of data including a test pattern, fail addresses of test results, and fail data.

The test modules 120 transmit and receives signals to and from the device under test 10. Each test module 120 has a plurality of functions for testing the device under test 10, including functions to set conditions, output a test signal, and receive a response signal from the device under test 10. Each test module 120 includes a signal input/output section 140 and a module control section 150.

Each signal input/output section 140 transmits and receives signals to and from the device under test 10. The signal input/output section 140 transmits to the device under test 10 a test signal based on the test pattern for testing the device under test 10, and compares an expected value to an output signal output by the device under test 10 in response to the test signal. The signal input/output section 140 includes a register and a memory for holding data to be input and output.

The register of the signal input/output section 140 is used to set setting values for an operation mode, timing delay amount, current, voltage, or the like and to hold a running state. The memory of the signal input/output section 140 stores test patterns, expected value data, fail data, log data, states of modules, etc.

Each module control section 150 executes a function program corresponding to the function designated by the test program, and accesses at least one of the register and the memory in the signal input/output section 140. The module control section 150 may perform access in word units to independently set the register in the signal input/output section 140. Transmission in word units includes PIO (Programmed Input/Output) transmission for inputting and outputting data using an I/O port of the CPU itself, for example. The module control section 150 includes a function program storage section 160, a function program executing section 170, and a function program writing section 180.

The function program storage section 160 stores a plurality of function programs corresponding to a plurality of functions. The function programs stored in the function program storage section 160 may include programs for executing a plurality of functions of the test module 120 for outputting a test signal, receiving a response signal from the device under test 10, and setting conditions according to a test for at least one of the register and the memory.

The function program executing section 170 reads from the function program storage section 160 a function program corresponding to the function designated by the test control section 110, and executes this function program. The function program executing section 170 transmits, in word units, one or more commands written in the read function program to the register and the memory in the signal input/output section 140, and sequentially executes the one or more commands.

Prior to testing, the function program writing section 180 receives a function program code from the test control section 110 and writes this code to the function program storage section 160. Here, the function program writing section 180 preferably receives the function program from the test control section 110 via a burst transmission, and it is preferable that this function program can be overwritten at a later time.

The hub 130 connects a plurality of the test control sections 110 and/or a plurality of the test modules 120 to each other via a cable, and relays transmission signals therebetween. The hub 130 is preferably connected to the test control sections 110 and/or test modules 120 by a universal or dedicated high-speed serial bus.

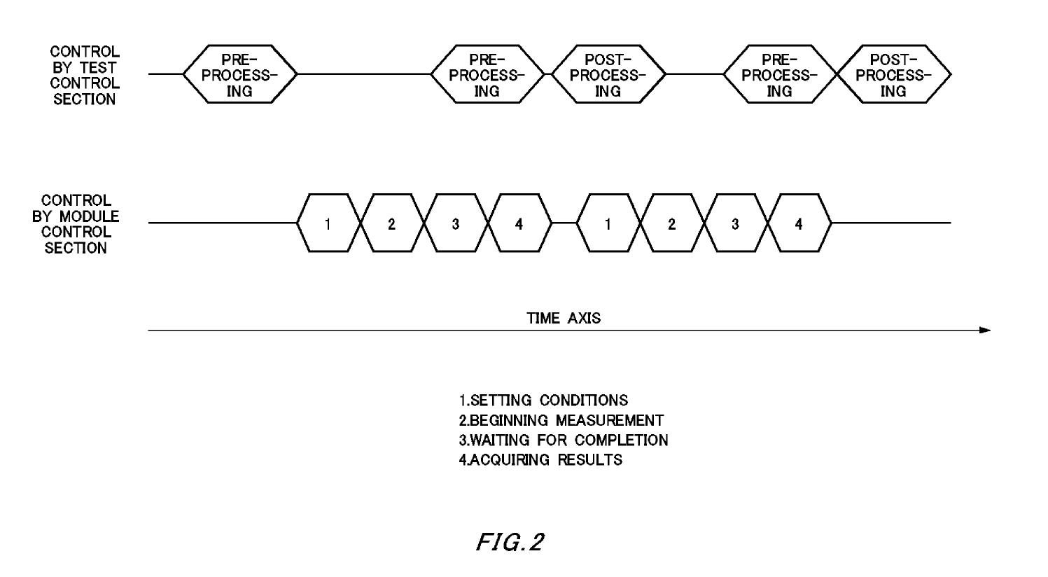

FIG. 2 shows the basics of the control process performed by the test apparatus 100 of the present embodiment on a horizontal time axis. The control process of the test apparatus 100 is preferably mostly divided into control by the test control section 110 and control by the module control sections 150. The test control section 110 instructs one or more test modules 120 to execute the function designated by the test program.

The test control section 110 may transmit to a target test module 120, via burst transmission, a function ID assigned to each function, a test pattern and parameters used to execute the function, or the like. Instead, the test control section 110 may perform this transmission by transmitting a plurality of packets including a plurality of words. The above transmission corresponds to the control process indicated by “pre-processing” in FIG. 2. The test control section 110 receives, via burst transmission, measurement result data from the target test module 120. This receiving process corresponds to the control process indicated by “post-processing” in FIG. 2.

The module control section 150 in each test module 120 executes a designated process. For example, a module control section 150 may retrieve a function program based on the function ID and use the designated parameter to change an operation or setting value. The module control section 150 can execute the function program corresponding to the designated function by accessing machine language from the signal input/output section 140 in single word units.

In the example of FIG. 2, the module control section 150 executes operations of “setting conditions,” “beginning measurement,” “waiting for completion,” and “acquiring results,” according to the function program. As a result of the above, the control process performed by the test control section 110 on the test modules 120 can be realized with a burst transmission, thereby decreasing word-unit transmission, and control processes executed within a test module 120 can be executed with word-unit data transmission.

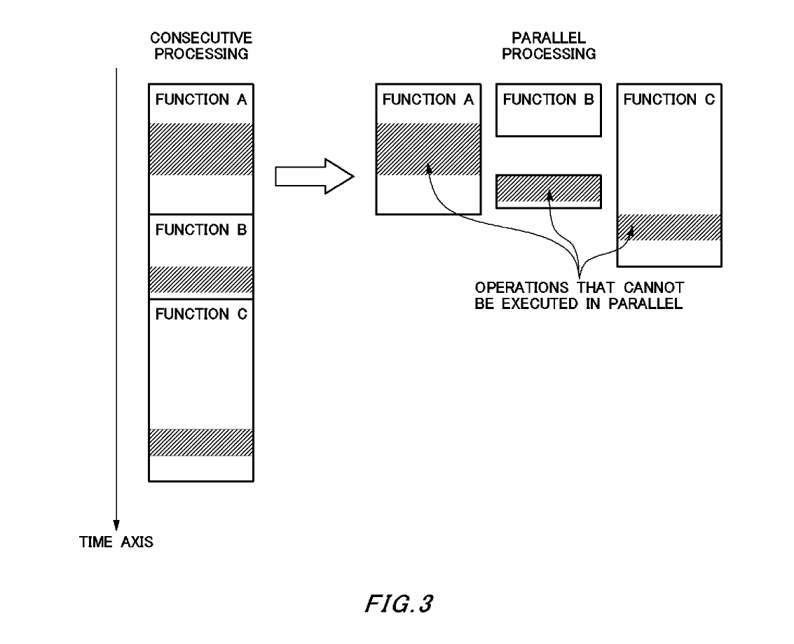

FIG. 3 shows the basics of function processes performed by the test apparatus 100 of the present embodiment on a vertical time axis. When a plurality of functions are designated by the test program, the test control section 110 may sequentially instruct a module control section 150 to execute the functions, and the module control section 150 may successively execute the function programs based on the designated functions. In the example of FIG. 3, the test apparatus 100 successively performs function A, function B, and function C.

Instead, the test control section 110 may transmit to the module control section 150, in a single burst transmission, the types of two or more functions to be executed by the module control section 150 and the parameters of the two or more functions. The module control section 150 may consecutively execute the function programs corresponding to the functions included in the burst transmission.

Instead, the module control section 150 may execute a plurality of function programs in parallel. In this case, the module control section 150 preferably executes in parallel the setting portions, which involve setting the signal input/output section 140, in the two or more function programs corresponding to the two or more functions, and executes in sequence the operation portions, which involve transmitting signals between the signal input/output section 140 and the device under test 10, according to the designation from the test control section 110 regarding the execution of two or more functions. The module control section 150 may execute in parallel, from among the function programs, routines whose orders of execution are determined and routines whose order of execution depend on a designated condition, for example.

It is possible for there to be operations that the signal input/output section 140 cannot execute in parallel with performing the operation of inputting and outputting signals to and from the device under test 10. For example, it is difficult for a real-time operation, such as a routine that requires a response within a prescribed time, to be executed in parallel with another operation. Accordingly, the module control section 150 may consecutively perform operations that cannot be executed in parallel, as shown by the twisting arrows in FIG. 3.

In the example of FIG. 3 where functions A to C are processed in parallel, since there is a portion at which processes of function A and function B that cannot be executed in parallel overlap temporally, the module control section 150 processes the overlapping operations in sequence. The module control section 150 reads the function program of each function A to C and processes in parallel the portions of functions A to C that can be executed in parallel. Next, when executing functions A and B having portions that cannot be executed in parallel, the module control section 150 selects function A and performs sequential processing.

Here, as a method for selecting which function to perform first from among functions that cannot be executed in parallel, the module control section 150 may follow instructions written in the test program or, if there are no such instructions written in the test program, may execute the function programs in the order in which they are read. As another example, an order of priority may be registered in advance, and the module control section 150 may execute these functions in the registered order. If function C can be processed in parallel with function A, the module control section 150 may process function A and function C simultaneously.

After finishing the successive processing of function A, the module control section 150 determines whether functions A to C can be processed in parallel and, if these functions can be processed in parallel, begins parallel processing. The module control section 150 switches between parallel processing and consecutive processing as appropriate until processing is completed for all of the function programs, thereby improving the overall processing speed for the functions of the test module 120 to be executed.

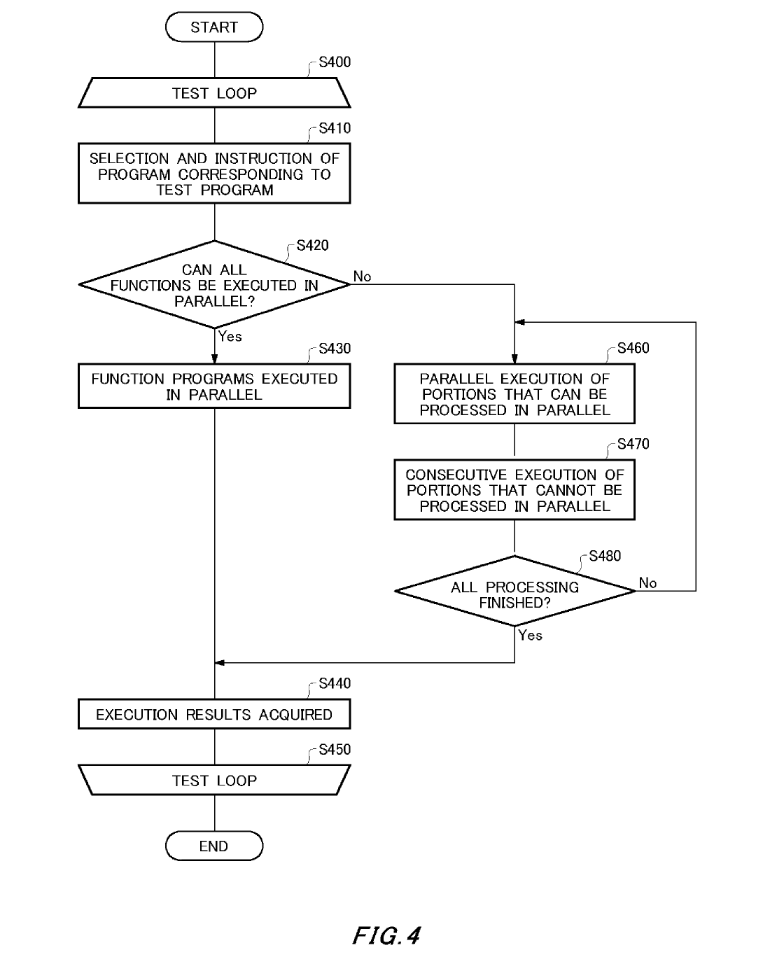

FIG. 4 shows a process flow of the test apparatus 100 according to the present embodiment. The test apparatus 100 repeats the loop from step S400 to step S450 of FIG. 4 to consecutively process the test program according to the test.

The test control section 110 instructs a module control section 150 in a test module 120, via a burst transmission including a plurality of words, to execute one or more functions designated by the test program (S410). Here, the test control section 110 may transmit to the module control section 150, using a single burst transmission, types and parameters of two or more functions to be executed by the module control section 150.

In response to the designation of two or more programs by the test control section 110, the module control section 150 judges whether all of the function programs corresponding to the two or more functions can be executed in parallel through the signal input/output section 140 (S420). For example, the module control section 150 may make this judgment based on the number of programs among the function programs that include operations that cannot be executed in parallel.

If there are no programs or one program including operations that cannot be executed in parallel, for example, the module control section 150 may judge that all of the programs can be executed in parallel and proceed to step S430. Here, if the test control section 110 designates execution of one program, the module control section 150 cannot perform parallel execution and therefore proceeds to step S430. The module control section 150 executes all of the function programs in parallel via the signal input/output section 140 (S430). The module control section 150 may transmit the control signal to the signal input/output section 140 using word-unit transmission.

If the designated function programs cannot be executed in parallel, the module control section 150 repeats the process loop from step S460 to S480 for the function program. The module control section 150 performs parallel execution of the portion of the function programs that can be executed n parallel, starting from the top (S460). For example, the module control section 150 perform parallel execution for an operation of setting parameters, an operation of confirming setting values, a routine whose order of execution is determined, and a routine whose order of execution depends on a designated condition.

Next, the module control section 150 consecutively executes the portions of the function program that cannot be executed in parallel (S470). For example, when executing a function of waiting for a response from the device under test 10 or a function of locking and testing the device under test 10, the module control section 150 takes exclusive rights of this program and performs consecutive execution.

Next, the module control section 150 checks, at the top of a portion that cannot be read in parallel, whether execution is completed for portions in each function that cannot be executed in parallel and that are to be executed earlier. After confirming that execution of all portions that should be executed earlier is complete, the module control section 150 executes the portion that cannot be executed in parallel. The module control section 150 continues performing consecutive execution until execution of the portions that cannot be executed in parallel is finished.

If execution of the designated function program is not yet complete, the module control section 150 returns to step S460 and switches to parallel execution (S480). In this way, the module control section 150 switches between parallel execution and consecutive execution as appropriate to execute the designated function program. When execution of all of the function programs to be executed is finished, the module control section 150 moves to step S440 (S480).

The module control section 150 can acquire as needed from the signal input/output section 140, as an execution result the function programs, the output signal output by the device under test 10 in response to the test signal (S440). Instead, the module control section 150 may acquire the execution result from the signal input/output section 140 as needed in word units, during steps S430, S460, or S470 while the function program is being executed. The module control section 150 transmits the output signal of the device under test 10 to the test control section 110 using burst transmission. The module control section 150 may perform burst transmission during the test program loop from step S400 to step S450, or may instead transmit all of the data in a burst transmission after all of the tests are finished.

The test module 120 repeats the loop from step S400 to step S450 to sequentially execute the designated functions until the test program is finished. The test apparatus 100 ends testing when the test program is finished, and stores and/or displays test results that are based on one or more measurement results received in a burst transmission from the test control section 110.

As a result of the operation of the test apparatus 100 according to the above embodiment, the test apparatus 100 can perform testing in which signal transmission between the test control section 110 and the module control section 150 is achieved using burst transmission and signal transmission between the module control section 150 and the signal input/output section 140 is achieved using word-unit transmission. Accordingly, increased latency due to the transmission of small amounts of data can be prevented during transmission between the test control section 110 and the module control section 150, and the test apparatus 100 can effectively use the high-speed transmission function of a universal or dedicated high-speed serial bus. Furthermore, the test apparatus 100 can perform effective data transmission with a low-latency parallel bus, without creating overhead due to parallel-serial conversion and encryption of the transmission between the module control section 150 and the signal input/output section 140.

By using a universal high-speed serial bus between the test control section 110 and the module control section 150, the test apparatus 100 can allow a physical distance between the test control section 110 and the module control section 150, and so the module control section 150 can be disposed near the signal input/output section 140. In other words, the test apparatus 100 can increase the speed of the clock of the parallel bus between the module control section 150 and the signal input/output section 140. During testing, the test apparatus 100 described above can transmit and receive a large amount of data using a universal high-speed serial bus suitable for transmitting large amounts of data, and can transmit and receive data in word units using a parallel bus suitable for transmitting data in word units, and can therefore improve the throughput of device testing.

When a function of a test module 120 is executed, the test apparatus 100 can separate the operations based on whether the operations can be executed in parallel and can switch between parallel execution and consecutive execution as appropriate. As a result, the test apparatus 100 can improve the throughput of device testing.

The test apparatus 100 of the present embodiment described above includes one test control section 110 and two test modules 120 therein, and tests one device under test 10. However, the test apparatus 100 may independently test a plurality of devices under test 10 using a plurality of test modules 120, and/or may test a single device under test 10 using a plurality of test modules 120.

When a plurality of test modules 120 perform parallel testing, two or more test modules 120 may execute testing in synchronization. For example, the function program executing section 170 in each test module 120 may exchange information via the hub 130. As a result, the plurality of test modules 120 can achieve direct communication without communication through the test control section 110, and accurate synchronous operation can be achieved.

When two or more test modules 120 execute testing in synchronization, a separate synchronization network may be provided for at least two function program executing sections 170. As a result, the plurality of test modules 120 can directly transmit and receive a synchronization signal, and can therefore more accurately perform synchronous operation.

In the test apparatus 100 of the present embodiment described above, each module control section 150 executes a function program and accesses the signal input/output section 140. The module control section 150 may also set the signal input/output section 140 according to the function program or, prior to operation, read a state of the signal input/output section 140 and confirm that the state allows the signal input/output section 140 to receive the settings or to begin operation. When the signal input/output section 140 is in a state that does not allow for the reception of settings from the device under test 10, the test apparatus 100 waits to perform the setting until an acceptable state is reached, and can therefore cause the device under test 10 to execute the prescribed function while in a state allowing for the execution, thereby achieving stable operation.

While the embodiments of the present invention have been described, the technical scope of the invention is not limited to the above described embodiments. It is apparent to persons skilled in the art that various alterations and improvements can be added to the above-described embodiments. It is also apparent from the scope of the claims that the embodiments added with such alterations or improvements can be included in the technical scope of the invention.

What is claimed is:

1. A test apparatus that tests a device under test, comprising:
a test module that transmits and receives signals to and from the device under test; and
a test control section that executes a test program for testing the device under test and that instructs the test module to execute a function designated by the test program from among a plurality of functions of the test module, wherein the test module includes:
a signal input/output section that transmits and receives signals to and from the device under test; and
a module control section that executes a function program according to the function designated by the test program and that accesses at least one of a register and a memory in the signal input/output section.

2. The test apparatus according to claim 1, wherein
the test control section transmits to the module control section, using a burst transmission containing a plurality of words, a parameter and a type of a function to be executed by the module control section, and
the module control section accesses, in word units, the register and the memory in the signal input/output section.

3. The test apparatus according to claim 2, wherein
the test control section transmits to the module control section, using a single burst transmission, a type and a parameter of each of two or more functions to be executed by the module control section.

4. The test apparatus according to claim 1, wherein
the module control section sets the signal input/output section according to the function program or, prior to causing the signal input/output section to operate, reads a state of the signal input/output section to check whether the signal input/output section is in a state that allows for reception of the settings or initiation of the operation.

5. The test apparatus according to claim 1, wherein
in response to the test control section designating execution of two or more programs, the module control section executes in parallel setting portions for setting the signal input/output section and consecutively executes operation portions for inputting and outputting signals between the signal input/output section and the device under test, the setting portions and operation portions being portions of two or more function programs corresponding to the two or more functions.

6. The test apparatus according to claim 1, wherein
two or more test modules from among a plurality of the test modules are synchronized with each other using synchronous communication, and test at least one device under test.

7. The test apparatus according to claim 1, wherein the module control section includes:
a function program storage section that stores a plurality of the function programs corresponding to the plurality of functions;
a function program executing section that reads from the function program storage section a function program corresponding to a function designated by the test control section, and that executes the read function program; and
a function program writing section that receives a code of the function program from the test control section and writes the code to the function program storage section.
